(19) United States
(12) Patent Application Publication
(10) Pub. No.: US 2024/0391608 A1
(43) Pub. Date: Nov. 28, 2024

(54) Method, System and Storage Medium for Remaining Useful Life Prediction of Aircraft Engine Based on Gaussian Process Regression Integrated Deep Learning

(71) Applicant: Intelligent Fusion Technology, Inc., Germantown, MD (US)

(72) Inventors: Genshe CHEN, Germantown, MD (US); Hui HUANG, Germantown, MD (US); Jiaoyue LIU, Germantown, MD (US); Nichole SULLIVAN, Germantown, MD (US); Kuochu CHANG, Fairfax, VA (US)

(21) Appl. No.: 18/324,986

(22) Filed: May 28, 2023

(51) Int. Cl. B64F 5/60; G01M 15/14; G06N 3/08

(52) U.S. Cl. CPC B64F 5/60; G01M 15/14; G06N 3/08

(57) ABSTRACT

The present disclosure provides a method, a system and a storage medium for remaining useful life prediction of an aircraft engine based on gaussian process regression integrated deep learning. The method includes partitioning observation data into training data, validation data, and testing data; training a generative GPR model using training data to obtain a trained GPR model; using trained GPR model as a synthetic data generator to generate synthetic data; performing an averaging process to integrate the synthetic data and the training data to obtain integrated data; generating a plurality of data minibatches from the integrated data; feeding the plurality of data minibatches into a deep leaning model to train the deep leaning model; obtaining RUL prediction from trained deep learning model based on the validation data; and using the RUL prediction for further parameter training of the generative GPR model and the deep learning model.

### GOVERNMENT RIGHTS

The present disclosure was made with Government support under Contract No. N68335-20-F-0562, awarded by the United States Department of the Navy (DON). The U.S. Government has certain rights in the present disclosure.

### FIELD OF THE DISCLOSURE

The present disclosure generally relates to the field of deep learning technology and, more particularly, relates to a method, a system, and a storage medium for remaining useful life prediction of an aircraft engine based on gaussian process regression integrated deep learning.

### BACKGROUND

Aircraft engines are crucial components of various aviation systems. Reliability, stability, and safety during the lifetime operation of the aircraft engine are significant determinants of flight safety, which requires proper and efficient maintenance strategies. Conventional maintenance strategies perform scheduled preventive maintenance and unscheduled corrective maintenance, which are barely able to meet the higher demand of performance, readiness, and efficiency in numerous maintenance missions. Recently, condition-based maintenance (CBM) has become increasingly popular for its effectiveness in avoiding unexpected casualty loss and unnecessary maintenance activities and resource wasting. CBM is designed to perform maintenance failure by monitoring a system's condition including operation settings, health statuses, and related environments, and estimating the remaining useful life (RUL) based on historical sensor data. As one of the most significant tasks of CBM, the prediction of RUL has become increasingly important to aviation community.

Typically, the RUL prediction methods can be categorized into physics-based and data-driven based approaches. For the physics-based approach, degradation characteristics of the system need to be selected or constructed, which are normally produced by state space approaches or classical deterioration methods such as Weibull distribution, Eyring model, and Arrhenius model. However, physical degradation characteristics are typically difficult to obtain, assess and model, and thus have limited applications especially for complicated systems. For the data-driven based approach, the RUL prediction can be performed by learning the relationship between RUL and monitoring data, thereby determining the degradation characteristics directly from observations and further predicting the RUL with observed sensing data. Recently, deep learning techniques such as convolutional neural networks (CNN), long short-term memory (LSTM) networks, dense neural networks (DNN), and Bayesian neural networks (BNN) have been successfully applied to the task of RUL prediction. These techniques outperform existing conventional physics-based methods. For instance, CNN has been applied to extract the features of the sensor data for RUL prediction. In another study, LSTM has been used to build long-term time dependencies for modeling the sensor data features. In addition, BNN has been utilized to consider uncertainty issues of the sensor data when modeling the features for RUL prediction. However, these deep learning techniques all require large amounts of labeled sensor data in order to obtain a relatively reliable RUL prediction model. The scarcity of useful data leads to inaccurate determination of model parameters, which in turn results in poor RUL prediction performance. Furthermore, the sensor data observed from the monitoring process of component health conditions may contain random observation noises. The noises in the sensor data also limit the RUL prediction performance using deep learning methods.

### BRIEF SUMMARY OF THE DISCLOSURE

One aspect or embodiment of the present disclosure provides a method for remaining useful life prediction of an aircraft engine based on gaussian process regression (GPR) integrated deep learning (GIDL). The method includes partitioning observation data into training data, validation data, and testing data; training a generative GPR model using the training data to obtain a trained GPR model; using the trained GPR model as a synthetic data generator to generate synthetic data; performing an averaging process to integrate the synthetic data and the training data to obtain integrated data; generating a plurality of data minibatches from the integrated data; feeding the plurality of data minibatches into a deep leaning model to train the deep leaning model; obtaining RUL prediction from the trained deep learning model based on the validation data; and using the RUL prediction for further parameter training of the generative GPR model and the deep learning model.

Another aspect or embodiment of the present disclosure provides a system for remaining useful life prediction of an aircraft engine based on gaussian process regression integrated deep learning. The system includes a memory, configured to store program instructions for performing a method for RUL prediction of an aircraft engine based on GIDL; and a processor, coupled with the memory and, when executing the program instructions, configured for: partitioning observation data into training data, validation data, and testing data; training a generative GPR model using the training data to obtain a trained GPR model; using the trained GPR model as a synthetic data generator to generate synthetic data; performing an averaging process to integrate the synthetic data and the training data to obtain integrated data; generating a plurality of data minibatches from the integrated data; feeding the plurality of data minibatches into a deep leaning model to train the deep leaning model; obtaining RUL prediction from the trained deep learning model based on the validation data; and using the RUL prediction for further parameter training of the generative GPR model and the deep learning model.

Another aspect or embodiment of the present disclosure provides a non-transitory computer-readable storage medium, containing program instructions for, when being executed by a processor, performing a method for remaining useful life prediction of an aircraft engine based on gaussian process regression integrated deep learning. The method includes partitioning observation data into training data, validation data, and testing data; training a generative GPR model using the training data to obtain a trained GPR model; using the trained GPR model as a synthetic data generator to generate synthetic data; performing an averaging process to integrate the synthetic data and the training data to obtain integrated data; generating a plurality of data minibatches from the integrated data; feeding the plurality of data minibatches into a deep leaning model to train the deep leaning model; obtaining RUL prediction from the trained deep learning model based on the validation data; and using the RUL prediction for further parameter training of the generative GPR model and the deep learning model.

Other aspects or embodiments of the present disclosure may be understood by those skilled in the art in light of the description, the claims, and the drawings of the present disclosure.

### BRIEF DESCRIPTION OF THE DRAWINGS

The following drawings are merely examples for illustrative purposes according to various disclosed embodiments and are not intended to limit the scope of the present disclosure.

FIG. 1 depicts a flowchart of an exemplary method for RUL prediction of an aircraft engine based on GIDL according to various disclosed embodiments of the present disclosure.

FIG. 2 depicts an exemplary system architecture of RUL prediction of an aircraft engine based on GIDL according to various disclosed embodiments of the present disclosure.

FIG. 3 depicts a schematic of exemplary aircraft engine modules according to various disclosed embodiments of the present disclosure.

FIG. 4 depicts an exemplary gaussian process regression curve drawn from a mean of a posterior distribution according to various disclosed embodiments of the present disclosure.

FIG. 5A depicts an exemplary DNN model for RUL prediction according to various disclosed embodiments of the present disclosure.

FIG. 5B depicts an exemplary CNN model for RUL prediction according to various disclosed embodiments of the present disclosure.

FIG. 5C depicts an exemplary LSTM model for RUL prediction according to various disclosed embodiments of the present disclosure.

FIG. 5D depicts an exemplary BNN model for RUL prediction according to various disclosed embodiments of the present disclosure.

FIG. 6 depicts a RUL prediction schematic of an exemplary piece-wise linear degradation model according to various disclosed embodiments of the present disclosure.

FIG. 7A depicts a schematic of predicted RUL values using GIDL with corresponding DNN according to various disclosed embodiments of the present disclosure.

FIG. 7B depicts a schematic of predicted RUL values using GIDL with corresponding CNN according to various disclosed embodiments of the present disclosure.

FIG. 7C depicts a schematic of predicted RUL values using GIDL with corresponding LSTM according to various disclosed embodiments of the present disclosure.

FIG. 7D depicts a schematic of predicted RUL values using GIDL with corresponding BNN according to various disclosed embodiments of the present disclosure.

### DETAILED DESCRIPTION

References are made in detail to exemplary embodiments of present disclosure, which are illustrated in accompanying drawings. Wherever possible, same reference numbers are used throughout accompanying drawings to refer to same or similar parts.

In order to solve above problems, a Gaussian process regression (GPR) integrated deep learning (GIDL) approach is proved according to various embodiments of the present disclosure. Training data is extended via generative GPR model with averaging techniques to produce realistic emulated data for training more accurate RUL prediction models. The hyperparameters of both the generative GPR model and deep learning models are tuned during the training and validating process. Compared with standard deep learning methods that utilize original collected data for training and testing, the GIDL approach is able to handle datasets with limited size and noise issues, which is mainly due to the fact that the generative GPR model has the potential to oversample the ground truth model with the hyperparameters tuning process and therefore generate realistic training data for better RUL prediction.

A generative GPR model is utilized to integrate with deep learning models for extending the training data and further improving RUL prediction performance, which provides an innovative methodology for model learning with limited data. An averaging technique is employed to combine the original training data and the GPR generated data for training the deep learning model. Such “bootstrap” method has a potential to oversample the ground truth model with the integrated datasets and thus improve the RUL prediction performance. The techniques for aircraft engine RUL prediction performed using C-MAPSS datasets (provided by NASA) are compared. The results demonstrate that GIDL method achieves desirable performance for aircraft engine RUL prediction and outperforms other benchmark methods.

According to various embodiments of the present disclosure, a method for remaining useful life prediction of an aircraft engine based on GIDL is described hereinafter.

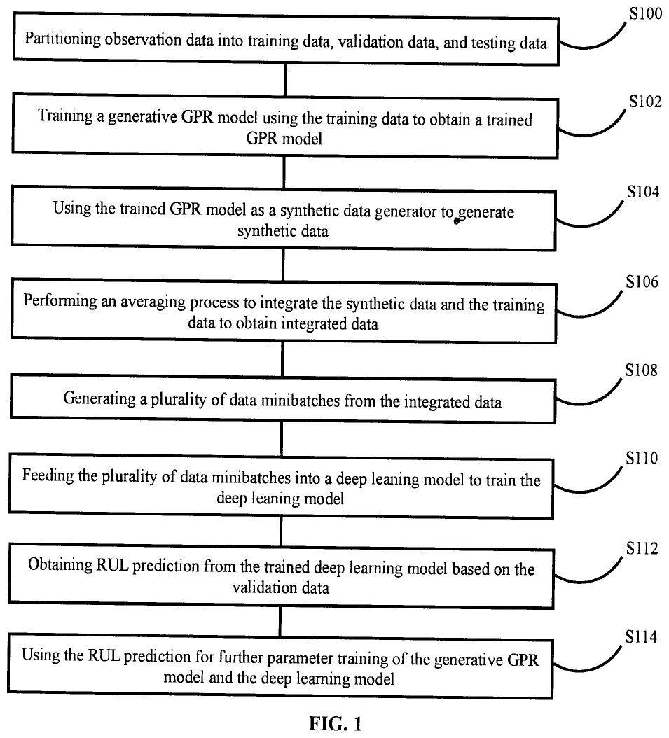

FIG. 1 depicts a flowchart of an exemplary method for RUL prediction of the aircraft engine based on GIDL according to various disclosed embodiments of the present disclosure.

In S100, observation data is partitioned into training data, validation data, and testing data.

In S102, a generative GPR model is trained using the training data to obtain a trained GPR model.

In S104, the trained GPR model is used as a synthetic data generator to generate synthetic data.

In S106, an averaging process is performed to integrate the synthetic data and the training data to obtain integrated data.

In S108, a plurality of data minibatches is generated from the integrated data.

In S110, the plurality of data minibatches is fed into a deep leaning model to train the deep leaning model.

In S112, RUL prediction is obtained from the trained deep learning model based on the validation data.

In S114, the RUL prediction is used for further parameter training of the generative GPR model and the deep learning model.

In one embodiment, the method further includes obtaining sensing data from sensors of the aircraft engine; inputting the sensing data into the trained deep learning model to provide RUL prediction of the aircraft engine; and determining a scheduling strategy for maintenance of the aircraft engine according to the RUL prediction of the aircraft engine, where the maintenance of the aircraft engine is performed according to the scheduling strategy.

In one embodiment, the generative GPR model is first trained with initial hyperparameters and further tuned empirically using the training data and the testing data.

In one embodiment, training the generative GPR model using the training data includes obtaining a posterior distribution based on standard Bayesian update.

In one embodiment, after obtaining the posterior distribution, the method further includes sampling data from the posterior distribution.

In one embodiment, RUL is calculated as a first passage time when a health status value of the aircraft engine exceeds a predefined failure threshold.

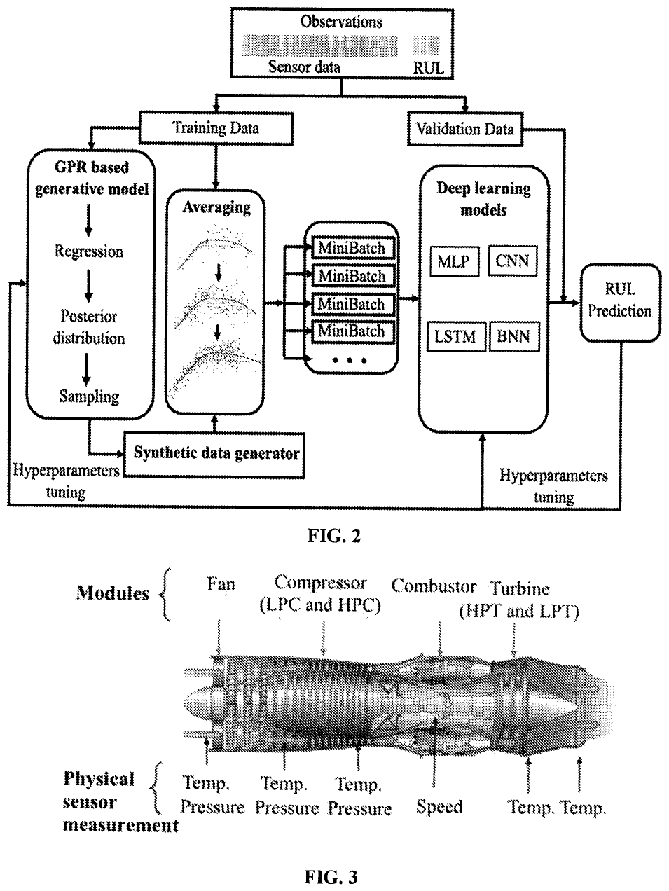

FIG. 2 depicts an exemplary system architecture of RUL prediction of the aircraft engine based on GIDL according to various disclosed embodiments of the present disclosure.

Referring to FIG. 2, the GIDL approach for RUL prediction is described in detail herein. The GIDL approach features in the generative GPR model with the averaging technique integrated into standard deep learning models are shown in FIG. 2. Available limited datasets from observations may be partitioned into training and testing data. For the training data, the generative GPR model may be employed to generate additional data by integrating synthetic data and original training data with the averaging technique. The generative GPR model may be first trained with initial hyperparameters and further tuned empirically in the training and testing process of the deep learning model. The learned GPR model may serve as a synthetic data generator, which can generate data samples that behave similarly to original training data according to learned patterns from the GPR model training. During the training process of the deep learning model, small batches of data may be generated after the averaging process, which may be fed into the deep learning model. The averaging process may combine original training data and the data from the generative GPR model. For different deep learning models, the input data may requires different formats, which results in different manners for generating the minibatches for training. A data preprocessing procedure may be required to apply the averaging technique to ensure oversampling effect. The testing data may be used for model performance evaluation and hyperparameters tuning for both the deep learning model and the generative GPR model. By optimizing all hyperparameters of the models, the GIDL approach may have potential to oversample a ground-truth model with limited dataset, thereby improving the RUL prediction performance.

According to various embodiments of the present disclosure, aircraft engine RUL prediction is described in detail hereinafter.

Readings from monitoring sensors of the aircraft engine may be highly correlated to the health condition of the aircraft engine. Assume that N sensors are employed for monitoring the aircraft engine. The time series sensor readings at jth time cycle are denoted as Xⱼ={X₁ⱼ, X₂ⱼ, . . . Xᵢⱼ=1, 2, . . . , N}, where i denotes the index of a sensor, j denotes the time cycle when the sensor data is recorded. The health status at jth time cycle is denoted as Yⱼ. Formally, Yⱼ and the RUL may be defined as:

$${Y}_{j} = f ( {X}_{j} , {X}_{j - 1} , {X}_{j - 2} … ) \qquad ( 1 )$$

$$RUL = inf \{ k : {Y}_{j + k} \geq {Y}_{threshold} \} \qquad ( 2 )$$

where Y_{threshold} denotes a predefined failure threshold. RUL may be calculated as the first passage time when the health status value passes the failure threshold. Equation (1) defines the sensor data variation evolving with the health status of the engine which relies on previous status. The RUL prediction problem lies on the construction of the nonlinear function, ƒ which is associated with the health status and sensor data over time. To handle the complex model, DL techniques have been proven for their ability in modeling non-linearity and complicated relationships. However, as mentioned previously, the issue of limited data and the uncertainty caused by the noise sensors may have hampered the power of DL techniques.

According to various embodiments of the present disclosure, engine dataset for RUL prediction is described in detail herein. The NASA C-MAPSS dataset has been popularly used in aircraft engine RUL prediction. The data may be generated from the C-MAPSS commercial gas turbine engine simulator. Referring to FIG. 3, the gas turbine engine may include modules such as a fan, a low pressure compressor (LPC), a high pressure compressor (HPC), a low pressure turbine (LPT), and a high pressure turbine (HPT). In the simulator, the health status of the aircraft engine including five modules may be monitored via 21 on-board sensors by measuring the speed, temperature (temp.), pressure and other characteristics of each component (module). In the C-MPASS simulation, multiple engine profiles may be simulated, while the performance of each engine may gradually degrade due to fouling, corrosion, and other faults. The sensor measurements may be recorded as a snapshot for each flight cycle which is contaminated with noise to realistically emulate practical operating conditions.

TABLE 1

| Data Set | FD001 | FD002 | FD003 | FD004 |
|---|---|---|---|---|
| Training trajectories | 100 | 260 | 100 | 249 |
| Testing trajectories | 100 | 259 | 100 | 248 |
| Operating conditions | 1 | 6 | 1 | 6 |
| Fault conditions | 1 | 1 | 2 | 2 |

The dataset may be configured in 26 columns including engine number, time cycle, three operational sensor settings, and 21 sensor readings. For different operational settings, the C-MAPSS dataset may be divided into 4 subsets as shown in Table 1, where each subset may include training and testing datasets. On the one hand, in the training trajectories of the training dataset, historical run-to-failure sensor measurements of entire engine may be available along with entire life cycle until the engine totally fails. On the other hand, the testing trajectories of the testing dataset may contain sensor measurements that are truncated at certain time cycle before the engine failure, so that the RUL may be predicted at an earlier time based on given limited sensor measurements. In addition, in order to evaluate the performance of predicted RUL, true RUL values may be provided for the testing data according to embodiments of the present disclosure.

According to various embodiments of the present disclosure, Gaussian process regression is described in detail herein. GPR is a probabilistic technique for non-linear non-parametric regression that estimates the distribution of future equipment degradation states by constraining a prior distribution to fit available training data based on Bayesian learning. Training data may be taken from sequences of degradation measures collected from a set of sensors that monitor the health status of the aircraft engine degradation process. Given new degradation measures from newly obtained sensor readings (e.g., test trajectory), the distribution of the RUL may be estimated. Moreover, given a set of training data from an engine with a known RUL, the sensor readings of the degradation measures may be sampled from trained GPR model, and therefore more sensor data may be analyzed with the generative GPR model. Mathematically, for a regression model mapping from an input x to an output ƒ(x), GPR defines the prior for the output function ƒ(x) in a distribution over functions specified by a Gaussian process (GP). The GP is a collection of a finite number of random variables, which follows a joint Gaussian distribution. A real GP ƒ(x) is completely specified by its mean function μ(x) and its covariance function K(x, x′) as follows:

$$f ( x ) ∼ GP \{ μ ( x ) ; K ( x , {x}^{′} ) \} \qquad ( 3 )$$

$$μ ( x ) = E ( f ( x ) )$$

$$K ( x , {x}^{′} ) = E [ ( f ( x ) - μ ( x ) ) ( f ( {x}^{′} ) - μ ( {x}^{′} ) ) ]$$

where x denotes a vector of input values, and K(x, x′)denotes a covariance matrix containing the values evaluated for all possible pairs of inputs in x.

Above function represents the prior beliefs over the functions to be observed. In some embodiments, the prior mean and covariance functions may be determined by certain hyper-parameters. Although the choice of the covariance function can be specified by a user, multiple popular methods have been applied to determine corresponding hyper-parameters from training data, such as conjugate gradient optimizer that maximizes marginal likelihood of the training set with respect to the hyper-parameters. Given the prior information of the GP, the values of the hyper-parameters and a set of training data D{x, ƒ(x)}, the posterior distribution over functions may be derived by imposing restriction on the prior distribution to contain only above functions consistent with observed data. In other words, the output corresponding to the test input vector x⋅ may be drawn from a same GP as the training data D as follows:

$$[ \begin{matrix}f \\ f *\end{matrix} ] ∼ N ( [ \begin{matrix}μ \\ μ *\end{matrix} ] , [ \begin{matrix}K ( x , x ) + {σ}_{N}^{2} I & K ( x , x \text{*)} \\ K ( x * , x ) & K ( x * , x \text{*)}\end{matrix} ] ) \qquad ( 4 )$$

where ƒ* denotes a test output and σ_{N}²I denotes a variance of white Gaussian noise. The posterior distribution of the output ƒ*|D from the input vector x* may be derived based on standard Bayesian update as the following:

$$f * \vert x , f , x * ∼ N ( \overline{f} * , \sum \text{*)} \qquad ( 5 )$$

$$\overline{f} * = μ * + {K ( x * , x ) [ K ( x , x ) + {σ}_{N}^{2} I ]}^{- 1} ( f - μ )$$

$$\sum * = K ( x * , x \text{*)} - {K ( x * , x ) [ K ( x , x ) + {σ}_{N}^{2} I ]}^{- 1} K ( x , x \text{*)}$$

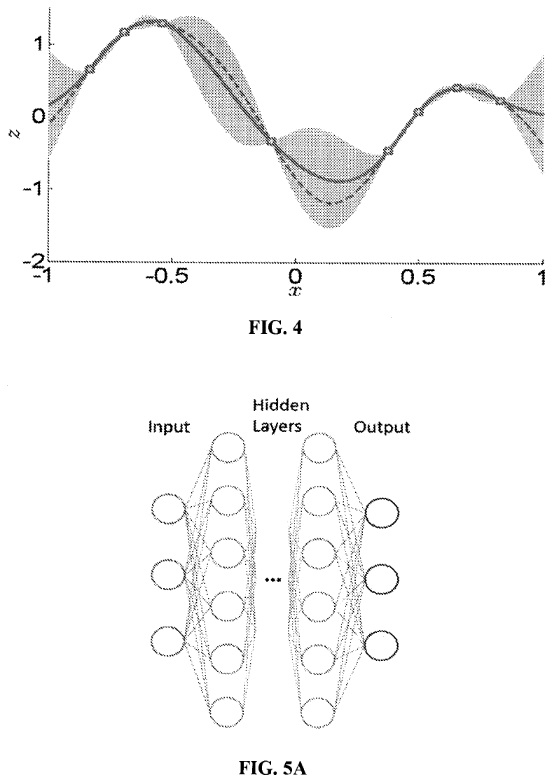

According to above equations, joint multivariate Gaussian distribution associate with the sensor data related to the RUL may be obtained. FIG. 4 depicts an exemplary gaussian process regression curve drawn from the mean of the posterior distribution according to various disclosed embodiments of the present disclosure. Exemplarily, “the mean of the posterior distribution” indicates that the value of the curve may be the mean value of the gaussian distribution of the gaussian process. Based on the posterior distribution, given a RUL label, more sensor data may be sampled from the posterior distribution and further utilized for more accurate model training. Referring to FIG. 4, the squares are data observations, the dashed curve is ground truth, the solid curve is the mean of the gaussian process, and the grey area is the confidence interval of z, where x may be an independent variable, and z may be a dependent variable from data observation.

The averaging technique is a useful tool that has been extensively applied in various theoretical and engineering problems. For example, the averaging technique has been employed to approximate solutions of nonlinear dynamic systems. The concept of averaging may also be applied in the GIDL approach in embodiments of the present disclosure. As shown in FIG. 2, the training data and generated data maybe combined using the averaging technique to produce more data to augment original dataset. In one embodiment, direct combination of original training data and generated data may not expand the dataset for desirable model training, that is, direct combination approach with multiple models training and testing may not lead to better RUL prediction performance compared to the model trained with original training data. The reason may be that generated data may be sampled from trained GPR model based on original training datasets which are contaminated with noise. With the averaging technique, the trajectory-based averages of the sensor data may mitigate noise contamination in an ensemble way. By generating the minibatches of combined data using the averaging technique, the training process of the DL model may utilize the data that can emulate oversampling of the ground truth model, which may result in a potential of achieving desirable performance of RUL prediction. In various embodiments of the present disclosure, the minibatches may contain an equal amount of data from both the original training data and combined data using the averaging technique. In order to obtain optimal averaging effect for combined data, weighted averaging may be employed, where the weighting coefficient of original dataset may be adjustable when performing hyperparameter tuning for model training.

According to various embodiments of the present disclosure, deep learning technique for RUL prediction is described in detail herein.

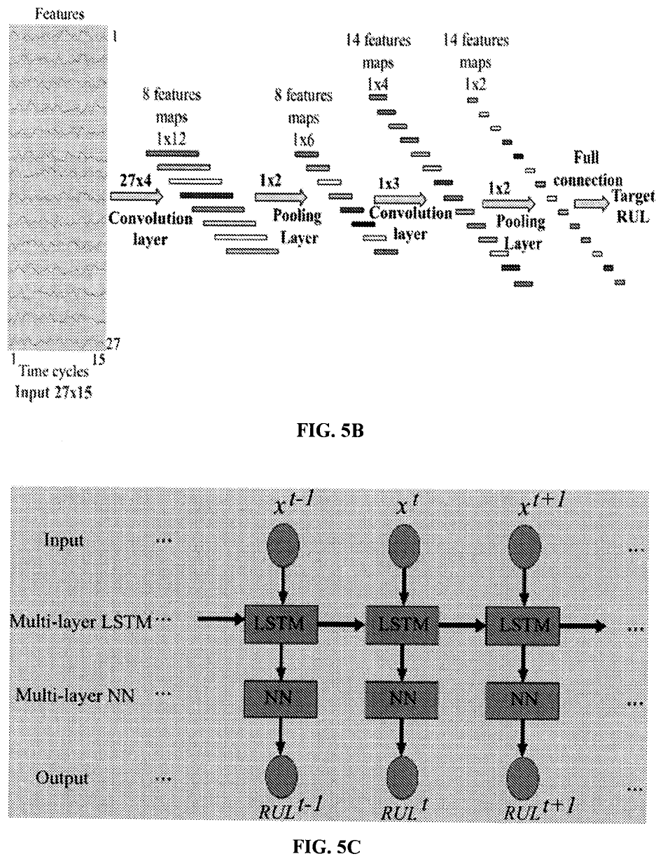

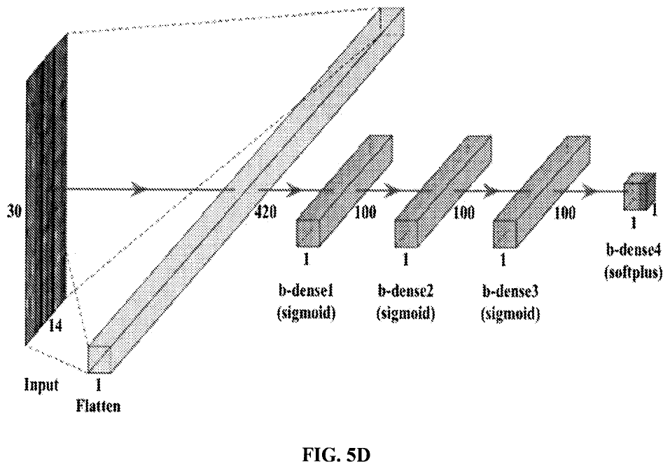

The RUL prediction aims to estimate the RUL of the aircraft engine using sensor data that monitor the status of the engine. In order to model the relationship between the RUL and sensor data, various techniques including deep learning have been developed to capture the features in the sensor data relevant to RUL. Deep learning refers to a family of learning models that utilize the data to learn high-level abstractions by automatically computing the hierarchical feature representation. Typically, a DL model may be built with multiple layers that perform nonlinear transformation on the output of previous layers as shown in FIG. 5A. The DL model can capture complicated relationships via different levels of hierarchy features with multiple non-linear transformations. For RUL prediction, the DL techniques including DNN, CNN, LSTM, and BNN have been widely used to model the sensor features. For instance, CNN is applied to extract the features of the sensor data for RUL prediction. The multivariate time series of the sensor data may be convolved with multiple convolutional kernels which may be further learned during the training process. The architecture of the CNN for RUL prediction is shown in FIG. 5B. The predicted RUL may be obtained from the output of the trained CNN model. LSTM may be used to build long-term time dependencies for modeling the sensor data features. LSTM may utilize the control of the information flow via input gate, forget gate, and output gate in an LSTM cell to preserve information for extended periods of time. FIG. 5C shows the deep learning LSTM model for RUL prediction. Moreover, BNN may be utilized to consider the stochastic nature of the sensor data when modeling the features for RUL prediction. FIG. 5D shows an example architecture of a BNN model. By introducing probability distribution in weights over the neural networks, predictive uncertainty may be quantified and learned from the training data which may result in robust BNN model for RUL prediction. According to various embodiments of the present disclosure, the GIDL approach is integrated with above-mentioned DL techniques, and resulting performance is compared with corresponding DL models for RUL prediction.

According to various embodiments of the present disclosure, experimental studies are conducted for evaluation of the GIDL approach. Comparisons are evaluated for RUL prediction performance of the aircraft engine associated with four DL techniques including DNN, CNN, LSTM, and BNN. For each approach, the hyperparameters including the number of layers and number of nodes or units in each layer may be tuned with a grid search and cross-validation procedure. Optimal hyperparameters may be selected for the performance comparison of RUL prediction.

According to various embodiments of the present disclosure, two performance measures, including the root mean square error (RMSE) and asymmetric scoring function (ASF), may be used to compare and evaluate RUL prediction performance. The RMSE is defined as follows:

$$R M S E = \sqrt{\frac{1}{N} {\sum }_{i = 1}^{N} {( {x}_{i} - {x}_{i}^{*} )}^{2}} \qquad ( 6 )$$

where N denotes a total number of data samples, x; denotes an ith estimated RUL, and x* denotes an ith true RUL.

The RMSE can measure the difference between estimated RUL and true RUL with equal weight to both early and late predictions. Since RUL prediction is ideally an early warning rather than a late prediction, especially in safety-critical situation, another scoring metric ASF is used in embodiments of the present disclosure, where ASF is defined as:

$$S = \{ \begin{matrix}{\sum }_{i = 1}^{N} ( {e}^{- \frac{{h}_{i}}{13} - 1} ) \\ {\sum }_{i = 1}^{N} ( {e}^{- \frac{{h}_{i}}{10} - 1} )\end{matrix} \qquad ( 7 )$$

where S denotes a computed score and hᵢ=xᵢ−x*. The scoring function penalizes late predictions more than early predictions based on the fact that if it is too late to perform maintenance according to the RUL, the equipment or component may fail unexpectedly and pose significant operational risk. Early prediction may be more acceptable as it only introduces premature maintenance rather than a safety hazard; however, such measure may also have some drawbacks. One drawback is that a single outlier may dominate overall performance score and bias true overall accuracy of the approach. The other drawback is that above scoring function may prefer approaches that artificially underestimate the RUL. Therefore, combined RMSE and ASF may provide fair comparison for RUL prediction performance.

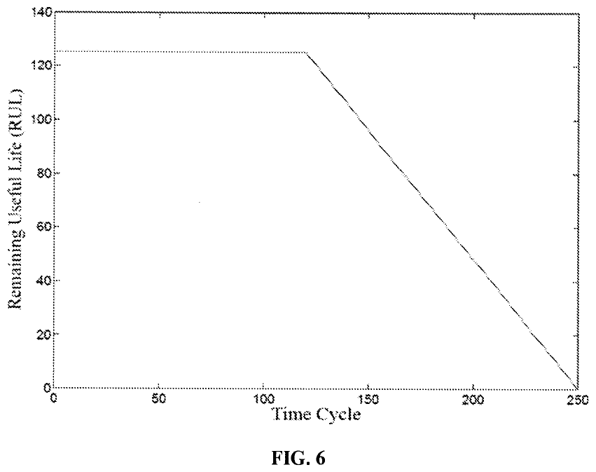

For real world RUL prediction of the aircraft engine, it is difficult to accurately predict the system health status at each time cycle without an accurate physics-based model. A simple value based on linear function that identifies actual useful time left before the engine failures may be assigned as the RUL. However, such approach may imply that the health status downgrades linearly with usage. In order to mitigate such issue, the RUL may be assigned based on a suitable degradation model such as a piece-wise linear degradation model. As shown in FIG. 6, the piece-wise linear degradation model assumes that the RUL target function limits the maximum value of the RUL until a threshold is reached, and after the threshold, the RUL value may decrease linearly with usage. This is based on the fact that the aircraft engine typically works normally and the health status has negligible degradation in early age. After a certain degree of wear or usage, the aircraft engine may start to degrade, which is consistent with a typical degradation model. Since the physics-based degradation model is difficult to be obtained, the piecewise linear model may be the most common choice for the RUL target function. In the C-MAPSS dataset (e.g., model), the maximum RUL may be configured as 125 for the dataset.

According to various embodiments of the present disclosure, data preprocessing is described in detail herein. Before training the deep learning models, data preprocessing may be performed to properly prepare the dataset for training. All sensor readings of the C-MAPSS dataset may be a part of the training data. As the sensor reading scale varies with different sensors, data normalization may be employed to ensure equal contribution from all sensor readings. In embodiments of the present disclosure, 21 sensor readings may be normalized to be within the range of [−1,1] with the min-max normalization [25] as follows:

$${x}_{norm}^{i , j} = \frac{2 ( {x}^{i , j} - {x}_{m i n}^{j} )}{{x}_{m ax}^{j} - {x}_{m i n}^{j}} - 1 \qquad ( 8 )$$

where x^{i,j} denotes an original ith data sample of a jth sensor, xₙₒᵣₘ^{i,j} denotes a normalized value of x^{i,j}, xₘₐₓ^{j} denotes a maximum value, and xₘᵢₙ^{j} denotes a minimum value of the original sensor data from jth sensor. Furthermore, as the sensor readings are multivariate time series, instead of using the single time step of sensor data, multiple time steps may be considered concurrently as the input of the deep learning models, which can take into account the time dependency information by analyzing the temporal sequence data in the models. Therefore, a sliding window segmentation may be performed on the temporal sensor readings to obtain overlapping segments with a fixed time step size. In one embodiment, given a time series of sensor reading with length of L and the window size of N, the time series may be converted into L−N+1 segments. For each segment, the RUL label of the last data sample in the segment may be considered as the label of the segment. After preprocessing the dataset, the segment of sensor readings and corresponding labels may be fed into the deep learning models for training. For the RUL labeling, as the piece-wise linear model is used for the RUL target function, the label of each segment of the training data may be rectified by artificially setting the RUL to 125 for all samples whose RUL is greater than 125. For the testing data, certain studies also applied the label rectification with a certain RUL maximum value. However, the maximum RUL may vary with different systems or datasets and only be estimated empirically, which indicates that the rectification of the testing RUL labels is equivalent to creating another version of testing data, which may lead to biased performance metrics towards the selected RUL maximum. Therefore, in embodiments of the present disclosure, original testing RUL labels without rectifying may be used for fair performance comparison and evaluation.

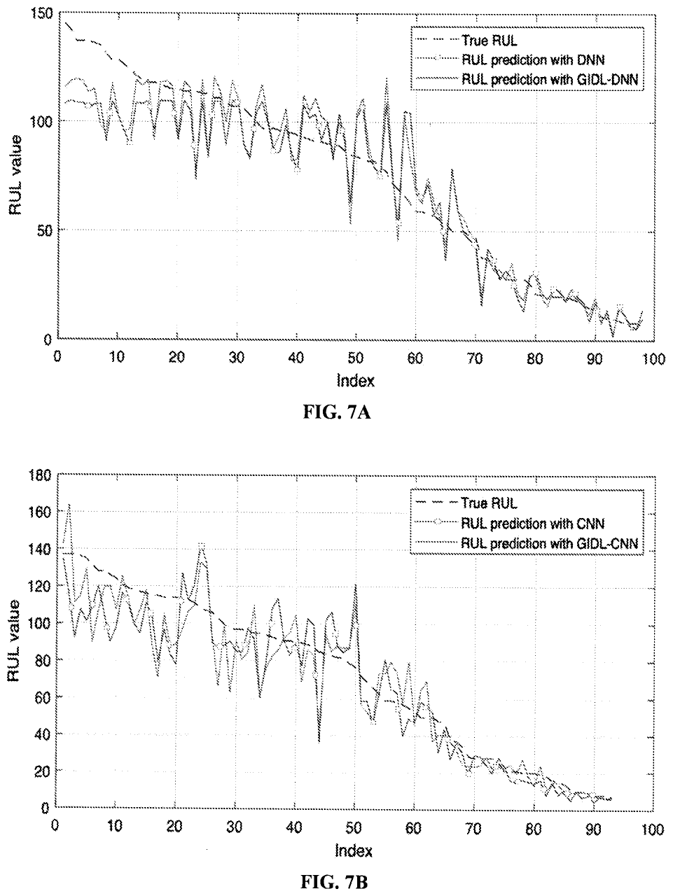

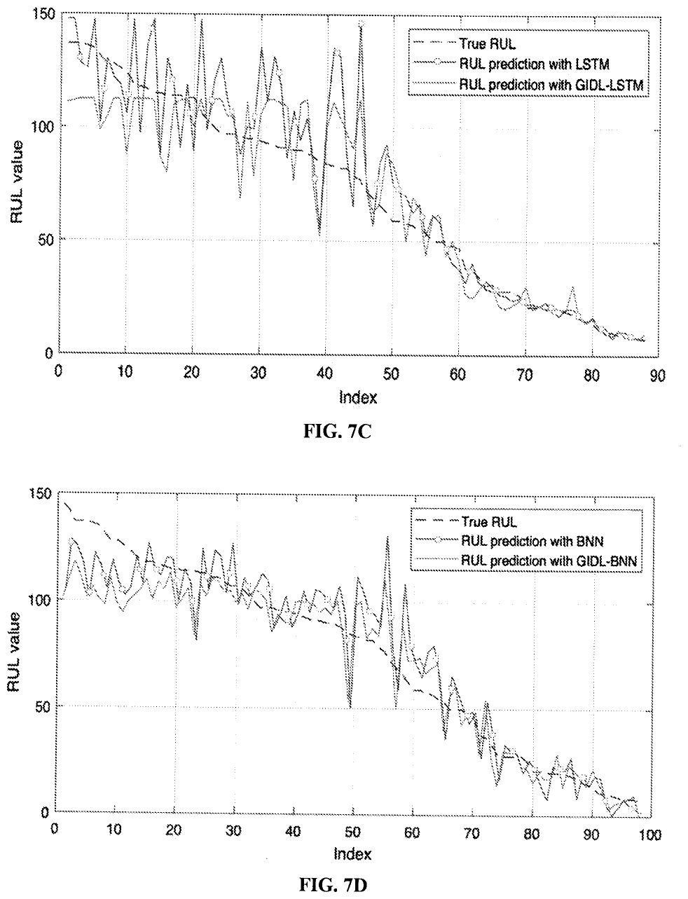

Four benchmark deep learning methods are selected to compare the RUL prediction performance with the GIDL approach. In order to fairly perform comparison, the benchmark methods are selected with published open source code with CNN, LSTM, and BNN models. The hyperparameters tuning is performed using a grid search with same search space. In one embodiment, the layer number of the DNN may range from 3 to 6, and node number in each layer may range from 16 to 512 for the hyperparameters tuning. For the GIDL approach, the hyperparameters tuning of the GPR may be performed towards the minimum loss of the corresponding deep learning models as shown in FIG. 2. Three kernels, including radial-basis function (RBF), Matern kernel, and rational quadratic kernel, are considered for the GPR model, where the hyperparameters are tuned within a fixed search space for different deep learning models. Optimal hyperparameters may be selected, and 5 trials of model training may be performed for averaging the RUL prediction results. FIGS. 7A-7D show the predicted RUL values with different deep learning techniques as well as corresponding GIDL methods using dataset FD001. Table 2 shows the performance comparison associated with the GIDL method and benchmark deep learning methods. As shown in Table 2, for each deep learning model, performance metrics, RMSE, and score are compared with the GIDL approach. It can be seen that the GIDL approach may perform better than the standard deep learning methods with DNN, CNN, and LSTM models. For the BNN model, two methods may demonstrate similar performance in both their RMSE and ASF scores. In one embodiment, the GIDL approach may achieve desirable RMSE and ASF score with datasets FD001 and FD003 but perform worse with datasets FD002 and FD004. The reason that the GIDL approach does not perform better than the standard deep learning method may be due to natural regularization effect caused by the Bayesian approach in the BNN model, which helps to reduce generalization errors that occur when noise is involved with the dataset. In addition, with the GIDL approach, the DNN and LSTM model may achieve the best RUL prediction performance among the benchmark methods for all the datasets. Overall, in most cases, the GIDL approach may achieve better RUL prediction performance than standard deep learning methods by extending the training dataset via GPR and averaging methods.

TABLE 2

| Models | Metrics | FD001 | FD002 | FD003 | FD004 |
|---|---|---|---|---|---|
| DNN | RMSE | 15.85 | 36.99 | 14.39 | 32.72 |
| | Score | 446.25 | 45216.11 | 398.34 | 15611.88 |
| GIDL-DNN | RMSE | 15.01 | 33.73 | 13.82 | 32.21 |
| | Score | 332.72 | 33034.13 | 305.18 | 12424.98 |
| CNN | RMSE | 16.66 | 30.68 | 17.36 | 38.56 |
| | Score | 518.72 | 14696.62 | 680.14 | 76566.23 |
| GIDL-CNN | RMSE | 15.75 | 30.44 | 16.47 | 36.41 |
| | Score | 328.93 | 11211.05 | 513.13 | 47111.69 |
| LSTM | RMSE | 15.38 | 24.69 | 15.85 | 30.55 |
| | Score | 734.17 | 6696.45 | 661.42 | 31213.93 |
| GIDL-LSTM | RMSE | 15.22 | 23.65 | 14.94 | 29.74 |
| | Score | 337.78 | 5524.37 | 595.74 | 27475.76 |
| BNN | RMSE | 15.36 | 32.81 | 14.39 | 31.95 |
| | Score | 464.39 | 58987.11 | 401.04 | 9180.04 |
| GIDL-BNN | RMSE | 15.29 | 33.52 | 14.35 | 32.02 |
| | Score | 311.85 | 54602.41 | 394.41 | 9655.34 |

In various embodiments of the present disclosure, the GIDL approach is provided by leveraging generative GPR model to extend the training data for deep learning models. By employing averaging techniques to combine original training data and generated data, the GIDL approach may potentially oversample the ground truth model with combined datasets. With such more robust combined dataset, the deep learning models may be able to achieve improved aircraft engine RUL prediction performance. According to embodiments of the present disclosure, the experimental results show that the GIDL approach may achieve improved RUL prediction performance in most of the cases. The GIDL approach may outperform various deep learning methods that have been widely used. The generative model integrated deep learning approach is provided to perform the remaining useful life of aircraft engines. The developed approach leverage Gaussian Process Regression to generate more similar data to better train the deep learning model and achieve desirable performance.

Various embodiments of the present disclosure provide a system for remaining useful life prediction of an aircraft engine based on gaussian process regression integrated deep learning. The system includes a memory, configured to store program instructions for performing a method for RUL prediction of an aircraft engine based on GIDL; and a processor, coupled with the memory and, when executing the program instructions, configured for: partitioning observation data into training data, validation data, and testing data; training a generative GPR model using the training data to obtain a trained GPR model; using the trained GPR model as a synthetic data generator to generate synthetic data; performing an averaging process to integrate the synthetic data and the training data to obtain integrated data; generating a plurality of data minibatches from the integrated data; feeding the plurality of data minibatches into a deep leaning model to train the deep leaning model; obtaining RUL prediction from the trained deep learning model based on the validation data; and using the RUL prediction for further parameter training of the generative GPR model and the deep learning model.

Various embodiments of the present disclosure provide a non-transitory computer-readable storage medium, containing program instructions for, when being executed by a processor, performing a method for remaining useful life prediction of an aircraft engine based on gaussian process regression integrated deep learning. The method includes partitioning observation data into training data, validation data, and testing data; training a generative GPR model using the training data to obtain a trained GPR model; using the trained GPR model as a synthetic data generator to generate synthetic data; performing an averaging process to integrate the synthetic data and the training data to obtain integrated data; generating a plurality of data minibatches from the integrated data; feeding the plurality of data minibatches into a deep leaning model to train the deep leaning model; obtaining RUL prediction from the trained deep learning model based on the validation data; and using the RUL prediction for further parameter training of the generative GPR model and the deep learning model.

The embodiments disclosed herein may be exemplary only. Other applications, advantages, alternations, modifications, or equivalents to the disclosed embodiments may be obvious to those skilled in the art and be intended to be encompassed within the scope of the present disclosure.

What is claimed is:

1. A method for remaining useful life (RUL) prediction of an aircraft engine based on gaussian process regression (GPR) integrated deep learning (GIDL), comprising:
partitioning observation data into training data, validation data, and testing data;
training a generative GPR model using the training data to obtain a trained GPR model;
using the trained GPR model as a synthetic data generator to generate synthetic data;
performing an averaging process to integrate the synthetic data and the training data to obtain integrated data;
generating a plurality of data minibatches from the integrated data;
feeding the plurality of data minibatches into a deep leaning model to train the deep leaning model;
obtaining RUL prediction from the trained deep learning model based on the validation data; and
using the RUL prediction for further parameter training of the generative GPR model and the deep learning model.

2. The method according to claim 1, further including:
obtaining sensing data from sensors of the aircraft engine;
inputting the sensing data into the trained deep learning model to provide RUL prediction of the aircraft engine; and
determining a scheduling strategy for maintenance of the aircraft engine according to the RUL prediction of the aircraft engine, wherein the maintenance of the aircraft engine is performed according to the scheduling strategy.

3. The method according to claim 1, wherein:
the generative GPR model is first trained with initial hyperparameters and further tuned empirically using the training data and the testing data.

4. The method according to claim 1, wherein:
training the generative GPR model using the training data includes obtaining a posterior distribution based on standard Bayesian update.

5. The method according to claim 4, after obtaining the posterior distribution, further including:
sampling data from the posterior distribution.

6. The method according to claim 1, wherein:
RUL is calculated as a first passage time when a health status value of the aircraft engine exceeds a predefined failure threshold.

7. A system, comprising:
a memory, configured to store program instructions for performing a method for remaining useful life (RUL) prediction of an aircraft engine based on gaussian process regression (GPR) integrated deep learning (GIDL); and
a processor, coupled with the memory and, when executing the program instructions, configured for:
partitioning observation data into training data, validation data, and testing data;
training a generative GPR model using the training data to obtain a trained GPR model;
using the trained GPR model as a synthetic data generator to generate synthetic data;
performing an averaging process to integrate the synthetic data and the training data to obtain integrated data;
generating a plurality of data minibatches from the integrated data;
feeding the plurality of data minibatches into a deep leaning model to train the deep leaning model;
obtaining RUL prediction from the trained deep learning model based on the validation data; and
using the RUL prediction for further parameter training of the generative GPR model and the deep learning model.

8. The system according to claim 7, wherein the processor is further configured to:
obtain sensing data from sensors of the aircraft engine;
input the sensing data into the trained deep learning model to provide RUL prediction of the aircraft engine; and
determine a scheduling strategy for maintenance of the aircraft engine according to the RUL prediction of the aircraft engine, wherein the maintenance of the aircraft engine is performed according to the scheduling strategy.

9. The system according to claim 7, wherein:
the generative GPR model is first trained with initial hyperparameters and further tuned empirically using the training data and the testing data.

10. The system according to claim 7, wherein:
training the generative GPR model using the training data includes obtaining a posterior distribution based on standard Bayesian update.

11. The system according to claim 10, wherein after obtaining the posterior distribution, the processor is further configured to:
sample data from the posterior distribution.

12. The system according to claim 7, wherein:
RUL is calculated as a first passage time when a health status value of the aircraft engine exceeds a predefined failure threshold.

13. A non-transitory computer-readable storage medium, containing program instructions for, when being executed by a processor, performing a method for remaining useful life (RUL) prediction of an aircraft engine based on gaussian process regression (GPR) integrated deep learning (GIDL), the method comprising:
partitioning observation data into training data, validation data, and testing data;
training a generative GPR model using the training data to obtain a trained GPR model;
using the trained GPR model as a synthetic data generator to generate synthetic data;
performing an averaging process to integrate the synthetic data and the training data to obtain integrated data;
generating a plurality of data minibatches from the integrated data;
feeding the plurality of data minibatches into a deep leaning model to train the deep leaning model;
obtaining RUL prediction from the trained deep learning model based on the validation data; and
using the RUL prediction for further parameter training of the generative GPR model and the deep learning model.

14. The storage medium according to claim 13, wherein the processor is further configured to:
obtain sensing data from sensors of the aircraft engine;
input the sensing data into the trained deep learning model to provide RUL prediction of the aircraft engine; and
determine a scheduling strategy for maintenance of the aircraft engine according to the RUL prediction of the aircraft engine, wherein the maintenance of the aircraft engine is performed according to the scheduling strategy.

15. The storage medium according to claim 13, wherein:
the generative GPR model is first trained with initial hyperparameters and further tuned empirically using the training data and the testing data.

16. The storage medium according to claim 13, wherein:
training the generative GPR model using the training data includes obtaining a posterior distribution based on standard Bayesian update.

17. The storage medium according to claim 16, wherein after obtaining the posterior distribution, the processor is further configured to:
sample data from the posterior distribution.

18. The storage medium according to claim 13, wherein:
RUL is calculated as a first passage time when a health status value of the aircraft engine exceeds a predefined failure threshold.
